(19) United States
(12) Patent Application Publication
(10) Pub. No.: US 2016/0372112 A1
(43) Pub. Date: Dec. 22, 2016

(54) Managing Interactions between Users and Applications

(71) Applicant: Amgine Technologies (US), Inc., Austin, TX (US)

(72) Inventors: Harold Roy Miller, Toronto (CA); Jonathan David Miller, Toronto (CA); L. James Valverde, JR., Washington, DC (US)

(21) Appl. No.: 15/183,216

(22) Filed: Jun. 15, 2016

Related U.S. Application Data
(60) Provisional application No. 62/181,660, filed on Jun. 18, 2015.

(51) Int. Cl. G10L 15/22; G10L 13/08; G10L 15/18; G10L 15/02; H04L 12/58; H04L 29/08

(52) U.S. Cl. CPC G10L 15/22; H04L 51/22; H04L 51/24; H04L 67/10; G10L 15/1822; G10L 15/02; G10L 13/08; G10L 2015/223

(57) ABSTRACT

A method for managing interactions between a user and applications is described. The method may commence with receiving a command from a user. The command may include a voice command. The method may continue with parsing the voice command. The parsing may include processing a natural language associated with the voice command. Based on the parsing, one or more key words may be derived from the voice command. The one or more key words may be associated with one or more executing devices, which may be associated with one or more applications. Based on the key words, an executing device for executing the voice command may be selected. The voice command may be directed to the executing device to execute the voice command.

### CROSS-REFERENCE TO RELATED APPLICATIONS

The present utility patent application is related to and claims the priority benefit under 35 U.S.C. 119(e) of U.S. provisional application No. 62/181,660, filed on Jun. 18, 2015, and titled “Managing Interactions between Users and Applications.” The disclosure of this related provisional application is incorporated herein by reference for all purposes to the extent that such subject matter is not inconsistent herewith or limiting hereof.

### TECHNICAL FIELD

The present disclosure relates to data processing and, more particularly, to managing interactions between users and applications.

### BACKGROUND

Some time ago, people lived in a world in which they used a typing pool and mail for communications. If people wanted to transmit information, they provided the data to the typing pool, received a physical letter, mailed it, and waited for a response. As the technology emerged, people obtained higher efficiencies from word processors and email. Then these capabilities were made available on mobile devices. The operating systems of the mobile devices allowed people to run and interact with multiple applications using a screen and a keyboard. Finally, a voice technology emerged that allowed people to control an application with voice commands.

However, to utilize functionalities of an application, a person needs to be physically in the application and actively run and manage the application. Alerts provided by the application can be useful, but the person has to go to the application in order to respond to the alerts. Thus, interactions of a user with the application or other users with which the user is trying to communicate through the application via text, email, phone, and the like cannot be duly managed by conventional systems.

### SUMMARY

This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

According to one example embodiment of the disclosure, a method for managing interactions between a user and applications is provided. The method may commence with receiving a command from a user. The command may include a voice command. The method may continue with parsing the voice command. The parsing may be performed by processing a natural language associated with the voice command. Based on the parsing, one or more key words may be derived from the voice command. The one or more key words may be associated with one or more executing devices, which may be associated with one or more applications. Based on the key words, an executing device for executing the voice command may be selected. The voice command may be directed to the executing device to execute the voice command.

According to another example embodiment of the disclosure, a system for managing interactions between a user and applications is provided. The system may include a processor and a parser in communication with the processor. The processor may be operable to receive a command from a user. The command may include a voice command. The parser may be operable to parse the voice command by processing a natural language associated with the voice command. The processor may be further operable to derive one or more key words from the voice command. The one or more key words may be associated with one or more executing devices. The one or more executing devices may be associated with one or more applications. The processor may be operable to select an executing device for executing the voice command. The processor may be further operable to direct the voice command to the executing device to execute the voice command.

Other example embodiments of the disclosure and aspects will become apparent from the following description taken in conjunction with the following drawings.

### BRIEF DESCRIPTION OF THE DRAWINGS

Embodiments are illustrated by way of example and not limitation in the figures of the accompanying drawings.

FIG. 1 illustrates an environment within which systems and methods for managing interactions between a user and applications can be implemented.

FIG. 2 shows the evolution of methods of user communications with people and applications.

FIG. 3 is block diagram showing various modules of a system for managing interactions between a user and applications.

FIG. 4 is a process flow diagram showing a method for managing interactions between a user and applications.

FIG. 5 is a block diagram showing example user communications with a plurality of applications.

FIG. 6 is a block diagram showing voice interactions of a user with a plurality of applications using a system for managing interactions between a user and applications.

FIG. 7 shows a schematic representation of user interactions with components of a system for managing interactions between a user and applications.

FIG. 8 is a block diagram showing interactions of a user with a plurality of applications using a system for managing interactions between a user and applications.

FIG. 9 shows a diagrammatic representation of a computing device for a machine in the exemplary electronic form of a computer system, within which a set of instructions for causing the machine to perform any one or more of the methodologies discussed herein can be executed.

### DETAILED DESCRIPTION

The following detailed description includes references to the accompanying drawings, which form a part of the detailed description. The drawings show illustrations in accordance with exemplary embodiments. These exemplary embodiments, which are also referred to herein as “examples,” are described in enough detail to enable those skilled in the art to practice the present subject matter. The embodiments can be combined, other embodiments can be utilized, or structural, logical, and electrical changes can be made without departing from the scope of what is claimed. The following detailed description is, therefore, not to be taken in a limiting sense, and the scope is defined by the appended claims and their equivalents.

The disclosure relates to managing interactions of a user with applications without running the applications. The user may start interacting with an application running on a user device by uttering a voice command. The voice command may be parsed by the user device to determine key words used in the voice command. The key words may be associated with a specific application running on the user device or on an executing device. For example, the voice command “Create an email” may be associated with an email application running on the user device, and the command “Provide car status” may be associated with an automobile control application running on an automobile control unit of a car associated with the user. The key words may be used to determine which application needs to the activated. For example, the key word “email” may be associated with the email application, the key word “car” may be associated with the automobile control application, and the like. Upon selection of an appropriate application, the voice command may be directed to a processor controlling the application, or to the executing device running the application, for execution of the voice command. For example, the command “Create an email” may be directed to a processor of the user device responsible for running the email application. The command “Provide car status” may be directed to a processor of the car as an executing device running the automobile control application.

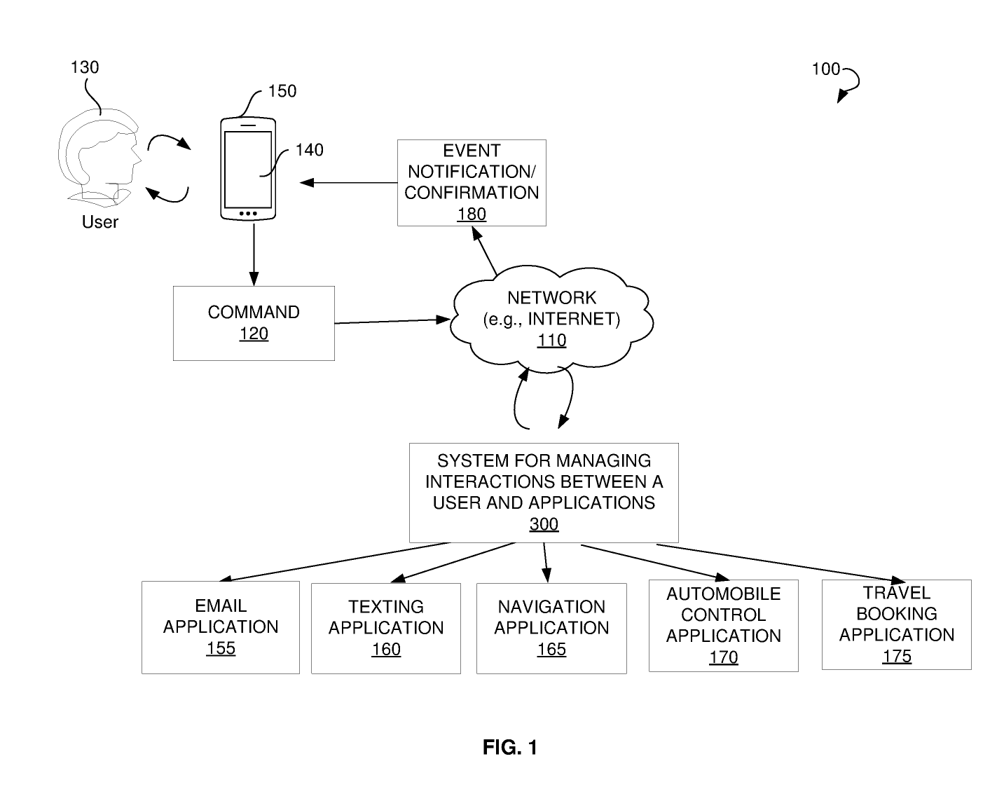

FIG. 1 illustrates an environment 100 within which systems and methods for managing interactions between a user and applications can be implemented, in accordance with some embodiments. A command 120 may be received from a user 130, for example, via a user interface 140 associated with a user device 150. The command 120 may include a voice command. The voice command may be processed so that text data may be obtained from a voice language input of the user 130 by speech-to-text conversion of an oral exchange with the user 130, or otherwise. In some embodiments, the user 130 may be asked, orally, one or more motivating questions to motivate the user 130 to provide relevant voice language input containing the command 120.

The command may be transmitted to a system 300 for managing interactions between a user and applications via a network 110. The network 110 may include the Internet or any other network capable of communicating data between devices. Suitable networks may include or interface with any one or more of, for instance, a local intranet, a Personal Area Network, a Local Area Network (LAN), a Wide Area Network (WAN), a Metropolitan Area Network, a virtual private network, a storage area network, a frame relay connection, an Advanced Intelligent Network connection, a synchronous optical network connection, a digital T1, T3, E1 or E3 line, Digital Data Service connection, Digital Subscriber Line connection, an Ethernet connection, an Integrated Services Digital Network line, a dial-up port such as a V.90, V.34 or V.34bis analog modem connection, a cable modem, an Asynchronous Transfer Mode connection, or a Fiber Distributed Data Interface or Copper Distributed Data Interface connection. Furthermore, communications may also include links to any of a variety of wireless networks, including Wireless Application Protocol, General Packet Radio Service, Global System for Mobile Communication, Code Division Multiple Access or Time Division Multiple Access, cellular phone networks, Global Positioning System (GPS), cellular digital packet data, Research in Motion, Limited duplex paging network, Bluetooth radio, or an IEEE 802.11-based radio frequency network. The network 110 can further include or interface with any one or more of an RS-232 serial connection, an IEEE-1394 (Firewire) connection, a Fiber Channel connection, an IrDA (infrared) port, a Small Computer Systems Interface connection, a Universal Serial Bus connection or other wired or wireless, digital or analog interface or connection, mesh or Digi® networking. The network 110 may be a network of data processing nodes that are interconnected for the purpose of data communication. The network 110 may include any suitable number and types of devices (e.g., routers and switches) for forwarding commands, content, and/or web object requests from each user and responses back to the users.

The user device 150, in some example embodiments, may include a Graphical User Interface for displaying the user interface 140 associated with the system 300. The user device 150 may include a mobile telephone, a personal computer (PC), a laptop, a smart phone, a tablet PC, and so forth. The system 300 may be a server-based distributed application; thus, the system 300 may include a central component residing on a server and one or more client applications residing on one or more user devices (including the user device 150) and communicating with the central component via the network. The user 130 may communicate with the system 300 via a client application available through the user device 150.

The system 300 for managing interactions between a user and applications may be associated with a number of applications, such as an email application 155, a texting application 160, a navigation application 165, an automobile control application 170, a travel booking application 175, and so forth. The system 300 for managing interactions between a user and applications may send event notifications or command execution confirmations 180 to the user device 150 to notify the user 130 about events associated with one or more of the applications or to notify the user 130 about execution of the command 120 provided by the user 130 in respect of one or more of applications.

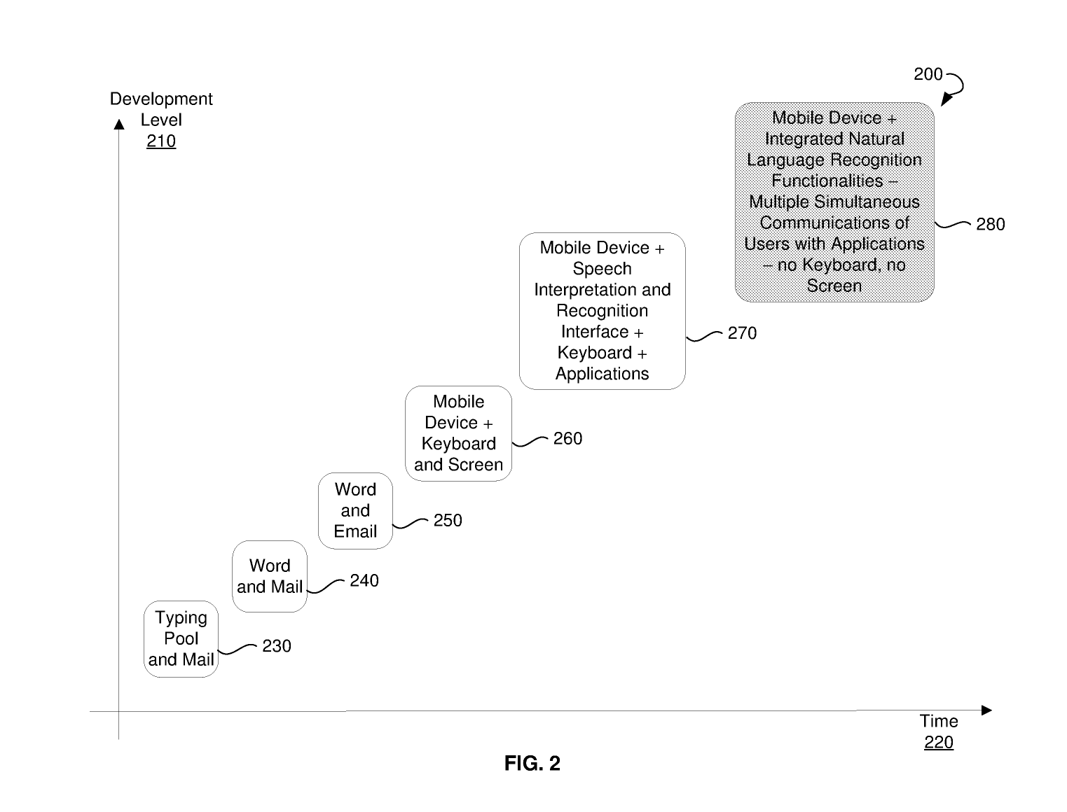

FIG. 2 shows a schematic diagram 200 representing evolution of development of methods for user communications with persons and applications. More specifically, the schematic diagram 200 shows a development level 210 of the methods for user communications with persons and applications over time 220. Elements shown on the schematic diagram 200 (specifically, a typing pool and mail 230, a word processor and mail 240, the word processor and email 250, a mobile device 260 having a keyboard and a screen, and a mobile device 270 having a speech interpretation and recognition interface, a keyboard and a number of applications) represent conventional methods of communications when a user needs to be physically in the application in order to utilize the functionality of the application. However, mobile devices 280 described in the present disclosure and having integrated natural language recognition functionalities may provide for multiple simultaneous communications of users with applications without involving screens or keyboards of the mobile devices.

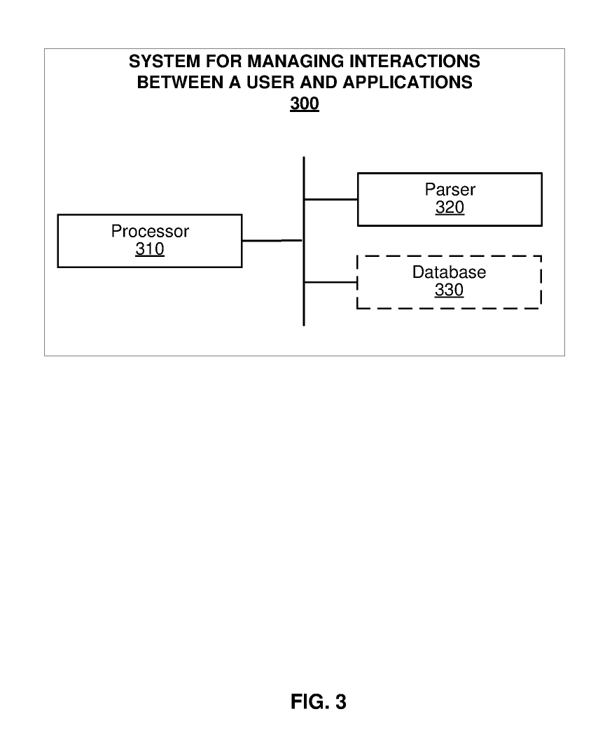

FIG. 3 is a block diagram showing various modules of a system 300 for managing interactions between a user and applications, in accordance with certain embodiments. The system 300 may include a processor 310, a parser 320, and optionally a database 330. The processor 310 may include a programmable processor, such as a microcontroller, a central processing unit (CPU), and so forth. In other embodiments, the processor 310 may include an application-specific integrated circuit or a programmable logic array, such as a field programmable gate array, designed to implement the functions performed by the system 300.

The processor 310 may be operable to receive a command from a user. The command may be in a form of a voice command. More specifically, the user may provide the voice command using a user device. In an example embodiment, the command may be associated with one or more of the following: reading an email, converting the email from text-to-speech, responding to the email, receiving a message, responding to multiple messages, taking a call, making a call, cancelling a call, adding one or more interlocutors to a call, recording a call, navigation searching, voice direction responding, finding one or more places of interest, providing car status, adjusting car settings, and so forth.

Upon receipt of the voice command by the processor 310, the parser 320 may be operable to parse the voice command. In an example embodiment, the parsing may include processing a natural language associated with the voice command. Upon parsing of the voice command by the parser 320, the processor 310 may be operable to derive one or more key words from the voice command.

Upon deriving the key words, the processor 310 may use the key words for selecting an executing device for executing the voice command. More specifically, the processor 310 may find the key words derived from the voice command to be associated with one or more executing devices. The executing devices may be associated with one or more applications. In an example embodiment, data associated with the correspondence between the key words and executing devices, as well as applications running on the executing devices, may be stored in the database 330.

The one or more applications may be running on the user device; therefore, the executing device may include a processor that is associated with execution of the one or more applications. In example embodiments, the processor that is associated with execution of the one or more applications may include the processor 310 or may be a separate processor. In a further example embodiment, the one or more applications may be running on remote devices (e.g., a navigation application running on a remote server). In this embodiment, the executing device may include a remote digital device, a virtual machine, and so forth. Thus, the directing of the voice command to the executing device may include directing the voice command to a further processor associated with the executing device being the remote digital device or the virtual machine. Upon the selection of the executing device, the processor 310 may direct the voice command to the executing device to execute the voice command. In an example embodiment, the executing devices may be associated with performing one or more of the following: a text message communication, an email communication, a navigation control, an automobile control, a travel booking, and so forth.

In a further example embodiment, the processor 310 may be further operable to receive, from the executing device, a notification associated with one or more events. The events may include one or more of the following: receiving an email, receiving a text message, receiving a call, and so forth. Upon receipt of the notification, the processor 310 may convert the notification into a speech. Furthermore, the processor 310 may be operable to provide the notification to the user by reproducing the speech.

In an example embodiment, the processor 310 may be further operable to receive a first notification associated with a first event. The first notification may be received from a first executing device of the one or more executing devices. The processor 310 may be further operable to receive a second notification associated with a second event. The second notification may be received from a second executing device of the one or more executing devices. Based on the first notification and the second notification, the processor 310 may generate a third notification that may include data associated with the first event and the second event. The processor 310 may further convert the third notification into a speech and provide the third notification to the user by reproducing the speech. Therefore, a single notification (i.e., the third notification) may be used to notify the user about several events. These several events may be associated with a single application or each of the several events may be associated with a separate application.

In a further example embodiment, the processor 310 may be operable to receive a command execution confirmation from the executing device. Upon receipt of the command execution confirmation, the processor 310 may provide the command execution confirmation to the user by reproducing the command execution confirmation using a speech.

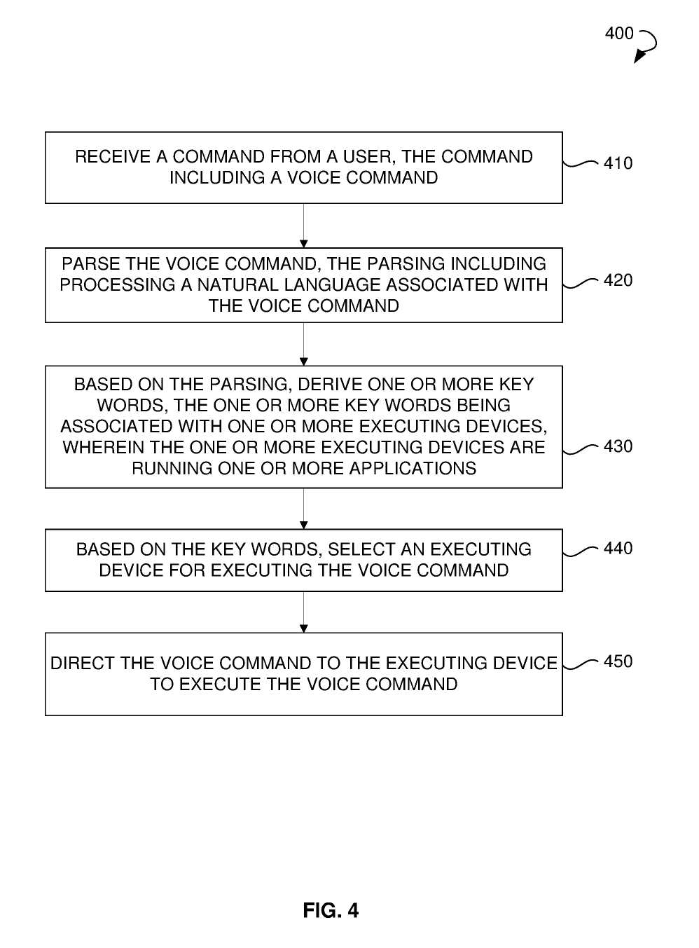

FIG. 4 is a process flow diagram showing a method 400 for managing interactions between a user and applications within the environment described above with reference to FIG. 1. The method 400 may commence with receiving a command from a user at operation 410. The command may include a voice command. In an example embodiment, the command may include one or more of the following: reading an email, text-to-speech converting the email, responding to the email, receiving a message, responding to multiple messages, taking a call, making a call, cancelling a call, adding one or more interlocutors to a call, recording a call, navigation searching, voice direction responding, finding one or more places of interest, providing car status, adjusting car settings, and so forth.

The method 400 may continue with parsing the voice command at operation 420. The parsing may include processing a natural language associated with the voice command. Based on the parsing, one or more key words may be derived from the voice command at operation 430. The one or more key words may be associated with one or more executing devices. The one or more executing devices may be associated with one or more applications; namely, the one or more applications may run on the one or more executing devices.

The method 400 may continue with selecting, based on the key words, an executing device for executing the voice command at operation 440. Upon the selection, the voice command may be directed to the executing device to execute the voice command at operation 450. More specifically, the voice command may be directed to a processor associated with the executing device. The processor may be the processor associated with the user device if the executing device includes the user device. Alternatively, the processor may be a further processor associated with a remote digital device or a virtual machine if the executing device includes the remote digital device or the virtual machine. In an example embodiment, the one or more executing devices may be associated with performing one or more of the following: a text message communication, an email communication, a navigation control, an automobile control, a travel booking, and so forth.

In an example embodiment, the method 400 may further include receiving, from the executing device, a notification associated with one or more events. The received notification may be converted into a speech and provided to the user by reproducing the speech. The one or more events may include receiving an email, receiving a text message, receiving a call, and so forth.

In an example embodiment, the method 400 may further include receiving, from the executing device, a command execution confirmation. The command execution confirmation may be provided to the user by reproducing the command execution confirmation by the speech.

In a further example embodiment, the method 400 may include receiving a first notification associated with a first event. The first notification may be received from a first executing device. The method 400 may further include receiving a second notification associated with a second event. The second notification may be received from a second executing device. Based on the first notification and the second notification, a third notification may be generated. The third notification may include data associated with the first event and the second event. Upon generation of the third notification, the third notification may be converted into a speech and provided to the user by reproducing the speech.

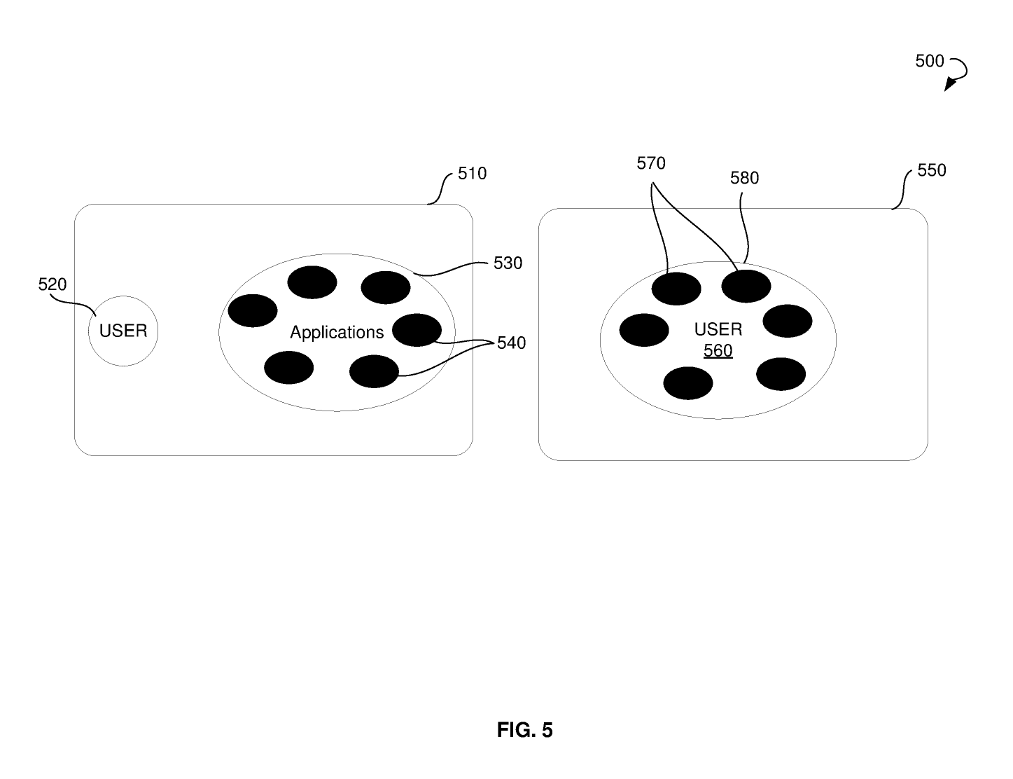

FIG. 5 shows a schematic representation 500 of diagrams 510 and 550 of user communications with a plurality of applications. In the diagram 510, a user 520 is located outside of an environment 530 of applications 540. Therefore, each time the user 520 wants to interact with one of the applications 540, the user 520 may need to launch or to open the one of the applications 540 (i.e., be physically “in the application”).

The diagram 550 shows a user 560 allowed to interact with and manage communications between applications 570 within an environment 580 using voice only. Therefore, the user 560 may not need to manually open one of the applications 570 each time the user 560 wants to interact with the one of the applications 570. The activity integrated into applications 570 and controlled by the user 560 using voice commands may include text messages from multiple people, email, phone calls, navigation, automobile control, and so forth.

More specifically, the user 560 can practically manage applications and capabilities related to phone calls, text messages, emails, and navigation. According to the present disclosure, the user 560 can have a single application allowing the user 560 to interact with this application and incorporating all the mentioned capabilities and applications seamlessly and concurrently. The user 560 can interact with the application by voice only. Thereby, the user 560 can manage the bi-directional communications with the applications and other users associated with the applications.

Therefore, the system for managing interactions between a user and applications of the present disclosure can maintain intelligent statefulness with the user and the environment around the user with respect to the applications and can intelligently manage all the interactions between the user and the world around the user, any time and in any place.

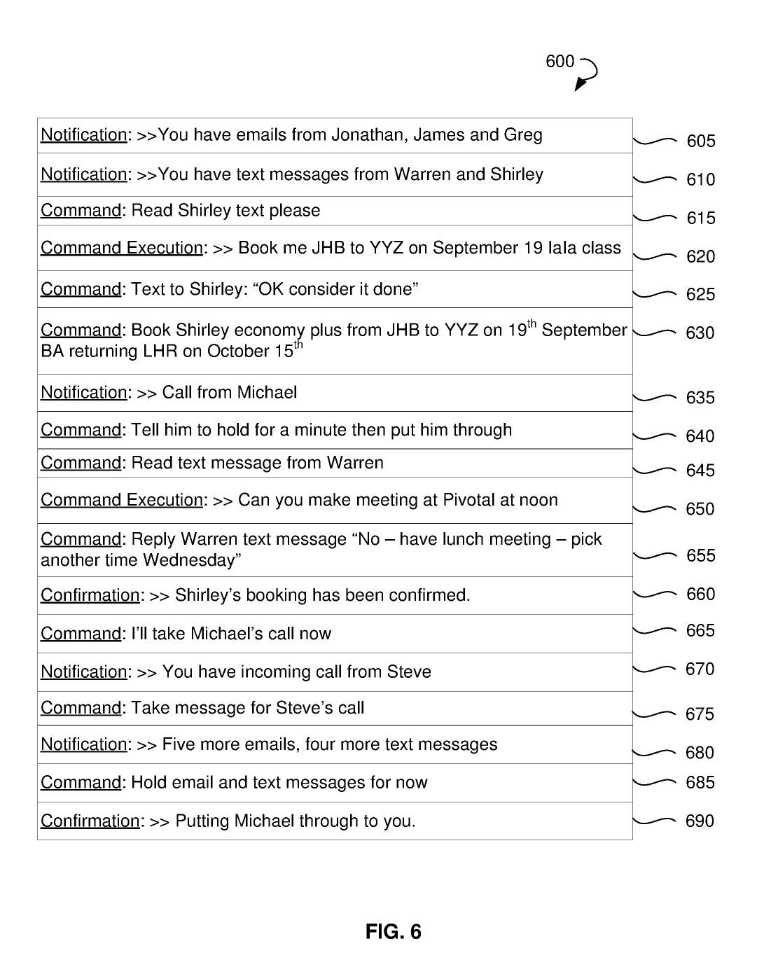

FIG. 6 is a schematic diagram 600 showing a voice interaction of a user with a plurality of applications using a system for managing interactions between a user and applications. The interaction of the user with the plurality of applications may start, for example, with receiving by the user, from the system for managing interactions between a user and applications, a notification 605. The notification 605 may include a voice notification, such as, for example, “You have emails from Jonathan, James and Greg.” The system for managing interactions between a user and applications may further provide a notification 610 to the user. The notification 610 may be, for example, as follows: “You have text messages from Warren and Shirley.” The user may provide a command 615 to the system for managing interactions between a user and applications in response to the received notification 610. The command 615 may include a voice command, such as “Read Shirley text please.” The system for managing interactions between a user and applications may execute the command 615 of the user, for example, by reproducing by speech a text message 620 from Shirley (for example, “Book me JHB to YYZ on September 19 IaIa class”). In response to reproducing of the text message 620, the user may provide further commands to the system for managing interactions between a user and applications (for example, a command 625, such as “Text to Shirley ‘OK consider it done’,” and a command 630, such as “Book Shirley economy plus from JHB to YYZ on 19^{th} September BA returning LHR on October 15^{th}”).

The system for managing interactions between a user and applications may further provide a notification 635 to the user. The notification 635 may be, for example, as follows: “Call from Michael.” In response to the notification 635, the user may provide multiple voice commands, such as a command 640 and a command 645. The command 640 may instruct the system for managing interactions between a user and applications to “Tell him to hold for a minute then put him through.” The command 645 may be “Read text message from Warren” and may relate to one of the previous notifications, such as the notification 610. In response to the command 645, the system for managing interactions between a user and applications may execute the command 645 of the user (for example, by reading a text message 650 “Can you make meeting at Pivotal at noon”). The user may respond to the text message 650 by providing a command 655 (for example, “Reply Warren text message ‘No—have lunch meeting—pick another time Wednesday’”).

The system for managing interactions between a user and applications may provide a command execution confirmation 660 relating one of the previous commands, namely the command 630. The command execution confirmation 660 may be reproduced by the system for managing interactions between a user and applications, for example, in the following form: “Booking of Shirley has been confirmed.” The user may further accept the call, about which the user was informed in the notification 635, by providing a command 665, such as “I'll take Michael's call now.”

The system for managing interactions between a user and applications may further provide a notification 670 to the user (for example, “You have incoming call from Steve”). The user may not respond to the call about which the notification 670 notifies and may provide a command 675, such as “Take message for Steve's call.” The system for managing interactions between a user and applications may further provide a notification 680 notifying the user that “Five more emails, four more text messages are received.” The user may provide a command 685 with an instruction not to reproduce the messages (for example, “Hold email and text messages for now”). The system for managing interactions between a user and applications may further provide a command execution confirmation 690 informing about starting a call in response to the command 665 of the user. The command execution confirmation 690 may be, for example, “Putting Michael through to you.”

In example embodiments, the user may use voice commands to send emails (e.g., by commands “Read me emails,” “From whom,” “Subject,” “Date range,” “Tell me basic content,” “Reply to individual, send copies to others”) and text (e.g., by command “Receive multiple messages,” “Respond to multiple messages”). Furthermore, the voice commands may be used to take calls, make calls, add people to a call, record a call, navigation control (such as voice activated searches, voice direction responses, providing road status, and finding nearest place of interest for the user, such as gas, Starbucks and the like), and automobile control (car status, lights, speed, settings).

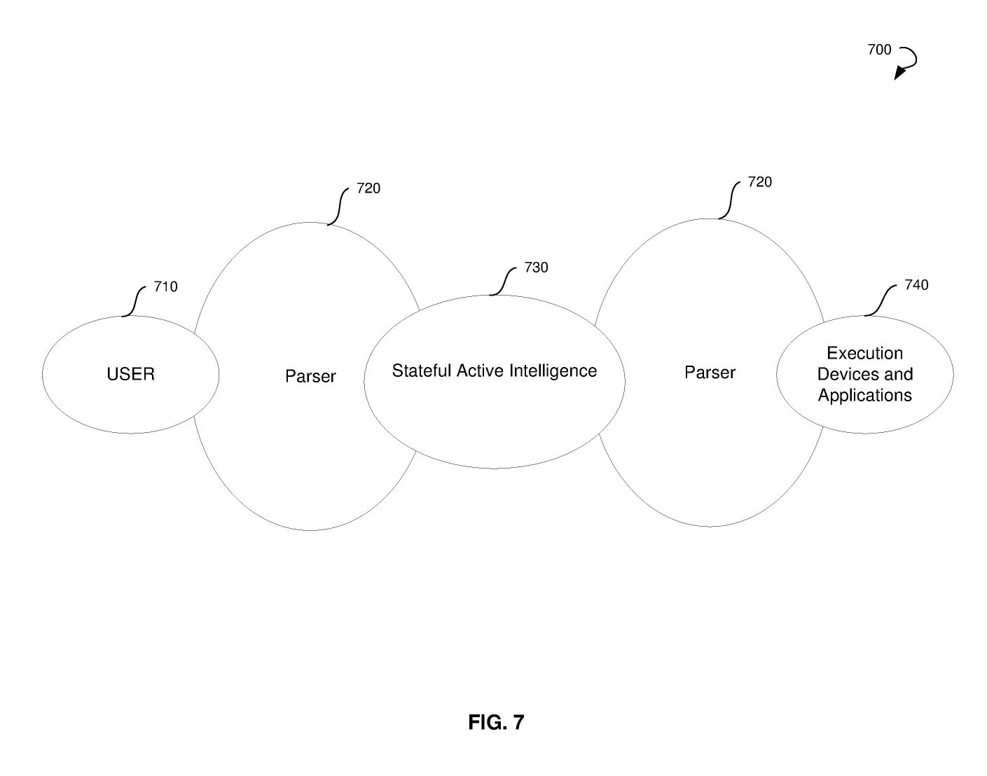

FIG. 7 shows a schematic representation 700 of interactions of a user 710 with components of a system for managing interactions between a user and applications. More specifically, the system (not shown) for managing interactions between a user and applications may include a parser 720. The parser 720 may be operable to perform semantic natural language processing of a voice command provided by the user 710. The semantic natural language processing may be specialized for a user interface of a user device and for communications between various execution devices and applications 740. Thus, the system for managing interactions between a user and applications may provide stateful active intelligence 730 with respect to communications of the user 710 with the execution devices and applications 740 by covering the state-based contexts of all communications of the user 710 with the applications. In an example embodiment, the user 710 may be charged a predetermined service fee for utilizing the system or managing interactions between a user and applications. Thus, the system for managing interactions between a user and applications may allow the user 710 to interact with and simultaneously manage communications between people associated with a plurality of applications (e.g., people that perform a call to the user 710, send an email to the user 710, and the like) using only voice.

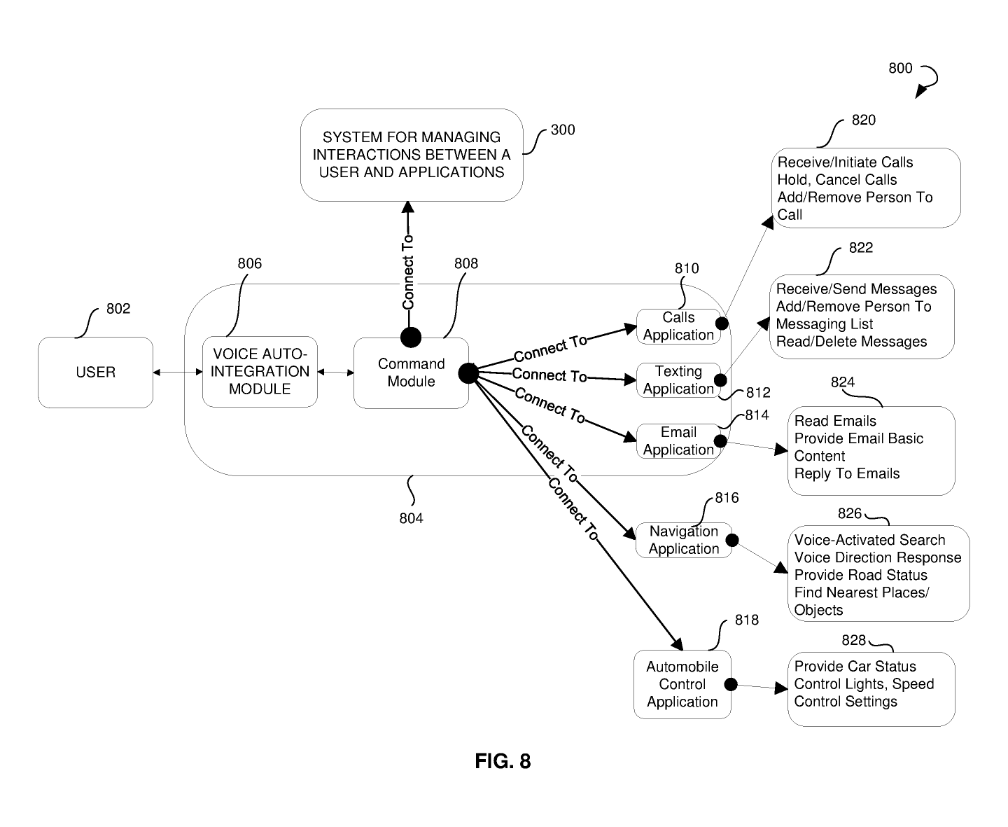

FIG. 8 is a block diagram 800 showing interactions of a user 802 with a plurality of applications using a system 300 for managing interactions between a user and applications. The user 802 may be associated with a user device 804, which may have a voice auto-integration module 806. In an example embodiment, the voice auto-integration module 806 may be used to receive voice commands of the user 802 and to provide notifications and command execution confirmations using speech by the system 300 to the user 802.

The system 300 may include a command module 808 operable to distribute voice commands of the user 802 to corresponding applications for execution of the voice commands by the corresponding applications. In an example embodiment, the command module 808 of the system 300 may include elements shown on FIG. 3, such as a processor, a parser, and a database.

In an example embodiment, the command module 808 of the system 300 may be located in the user device 804 and may be in communication with the voice auto-integration module 806. The command module 808 may receive commands from the user 802 and transmit commands to respective applications. More specifically, the command module 808 of the system 300 may be connected to a plurality of applications, such as a calls application 810, a texting application 812, an email application 814, a navigation application 816, an automobile control application 818, and so forth. Some of the applications may be running on the user device 804, such as the calls application 810, the texting application 812, and the email application 814; thus, a processor of the user device 804 may be the executing device. Other applications may be running on a remote executing device, such as the navigation application 816 running on a GPS navigation device, an automobile control application 818 running in an automotive navigation system, and so forth.

Each of the applications 810-818 may be responsible for initiating and executing commands received from the command module 808. In an example embodiment, the calls application 810 may perform commands 820, such as receiving calls, initiating calls, holding calls, cancelling calls, adding a person to a call, removing a person from a call, and the like. The texting application 812 may perform commands 822, such as receiving messages, sending messages, adding a person to a messaging list, removing a person from a messaging list, reading messages, deleting messages, and the like. Similarly, the email application 814 may perform commands 824, such as reading emails, providing basic content of emails, replying to emails, and so forth. The navigation application 816 may perform commands 826, such as performing a voice-activated search, providing a voice direction response, providing a road status, finding nearest places or objects, and so forth. The automobile control application 818 may perform commands 828, such as providing a car status, controlling lights and speed of a car, controlling setting of a car, and the like.

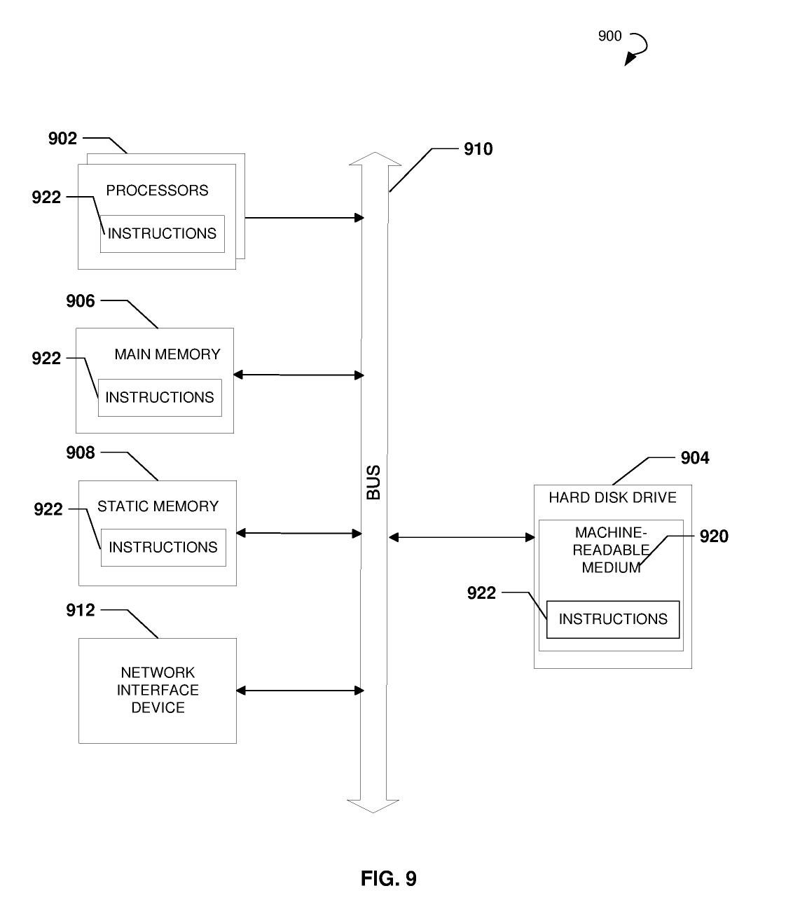

FIG. 9 shows a diagrammatic representation of a computing device for a machine in the exemplary electronic form of a computer system 900, within which a set of instructions for causing the machine to perform any one or more of the methodologies discussed herein can be executed. In various exemplary embodiments, the machine operates as a standalone device or can be connected (e.g., networked) to other machines. In a networked deployment, the machine can operate in the capacity of a server or a client machine in a server-client network environment, or as a peer machine in a peer-to-peer (or distributed) network environment. The machine can be a PC, a tablet PC, a set-top box, a cellular telephone, a digital camera, a portable music player (e.g., a portable hard drive audio device, such as an Moving Picture Experts Group Audio Layer 3 player), a web appliance, a network router, a switch, a bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The computer system 900 includes a processor or multiple processors 902, a hard disk drive 904, a main memory 906, and a static memory 908, which communicate with each other via a bus 910. The computer system 900 may also include a network interface device 912. The hard disk drive 904 may include a computer-readable medium 920, which stores one or more sets of instructions 922 embodying or utilized by any one or more of the methodologies or functions described herein. The instructions 922 can also reside, completely or at least partially, within the main memory 906 and/or within the processors 902 during execution thereof by the computer system 900. The main memory 906 and the processors 902 also constitute machine-readable media.

While the computer-readable medium 920 is shown in an exemplary embodiment to be a single medium, the term “computer-readable medium” should be taken to include a single medium or multiple media (e.g., a centralized or distributed database, and/or associated caches and servers) that store the one or more sets of instructions. The term “computer-readable medium” shall also be taken to include any medium that is capable of storing, encoding, or carrying a set of instructions for execution by the machine and that causes the machine to perform any one or more of the methodologies of the present application, or that is capable of storing, encoding, or carrying data structures utilized by or associated with such a set of instructions. The term “computer-readable medium” shall accordingly be taken to include, but not be limited to, solid-state memories, optical and magnetic media. Such media can also include, without limitation, hard disks, floppy disks, NAND or NOR flash memory, digital video disks, Random Access Memory (RAM), Read-Only Memory (ROM), and the like.

The exemplary embodiments described herein can be implemented in an operating environment comprising computer-executable instructions (e.g., software) installed on a computer, in hardware, or in a combination of software and hardware. The computer-executable instructions can be written in a computer programming language or can be embodied in firmware logic. If written in a programming language conforming to a recognized standard, such instructions can be executed on a variety of hardware platforms and for interfaces to a variety of operating systems.

In some embodiments, the computer system 900 may be implemented as a cloud-based computing environment, such as a virtual machine operating within a computing cloud. In other embodiments, the computer system 900 may itself include a cloud-based computing environment, where the functionalities of the computer system 900 are executed in a distributed fashion. Thus, the computer system 900, when configured as a computing cloud, may include pluralities of computing devices in various forms, as will be described in greater detail below.

In general, a cloud-based computing environment is a resource that typically combines the computational power of a large grouping of processors (such as within web servers) and/or that combines the storage capacity of a large grouping of computer memories or storage devices. Systems that provide cloud-based resources may be utilized exclusively by their owners, or such systems may be accessible to outside users who deploy applications within the computing infrastructure to obtain the benefit of large computational or storage resources.

The cloud may be formed, for example, by a network of web servers that comprise a plurality of computing devices, such as a client device, with each server (or at least a plurality thereof) providing processor and/or storage resources. These servers may manage workloads provided by multiple users (e.g., cloud resource consumers or other users). Typically, each user places workload demands upon the cloud that vary in real-time, sometimes dramatically. The nature and extent of these variations typically depends on the type of business associated with the user.

It is noteworthy that any hardware platform suitable for performing the processing described herein is suitable for use with the technology. The terms “computer-readable storage medium” and “computer-readable storage media” as used herein refer to any medium or media that participate in providing instructions to a CPU for execution. Such media can take many forms, including, but not limited to, non-volatile media, volatile media and transmission media. Non-volatile media include, for example, optical or magnetic disks, such as a fixed disk. Volatile media include dynamic memory, such as a system RAM. Transmission media include coaxial cables, copper wire, and fiber optics, among others, including the wires that comprise one embodiment of a bus. Transmission media can also take the form of acoustic or light waves, such as those generated during radio frequency (RF) and infrared (IR) data communications. Common forms of computer-readable media include, for example, a floppy disk, a flexible disk, a hard disk, magnetic tape, any other magnetic medium, a Compact Disc Read-Only Memory disk, a digital video disk, any other optical medium, any other physical medium with patterns of marks or holes, a RAM, a Programmable Read-Only Memory, an Erasable Programmable Read-Only Memory (EPROM), an Electrically Erasable Programmable Read-Only Memory, a FlashEPROM, any other memory chip or data exchange adapter, a carrier wave, or any other medium from which a computer can read.

Various forms of computer-readable media may be involved in carrying one or more sequences of one or more instructions to a CPU for execution. A bus carries the data to a system RAM, from which the CPU retrieves and executes the instructions. The instructions received by the system RAM can optionally be stored on a fixed disk either before or after execution by the CPU.

Computer program code for carrying out operations for aspects of the present technology may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a LAN or a WAN, or the connection may be made to an external computer (for example, through the Internet using an Internet Service Provider).

The corresponding structures, materials, acts, and equivalents of all means or steps plus function elements in the claims below are intended to include any structure, material, or act for performing the function in combination with other claimed elements as specifically claimed. The description of the present technology has been presented for purposes of illustration and description, but is not intended to be exhaustive or limited to the disclosure. Many modifications and variations will be apparent to those of ordinary skill in the art without departing from the scope and spirit of the disclosure. Exemplary embodiments were chosen and described in order to best explain the principles of the present technology and its practical application, and to enable others of ordinary skill in the art to understand the disclosure for various embodiments with various modifications as are suited to the particular use contemplated.

Aspects of the present technology are described above with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

Thus, computer-implemented methods and systems for managing interactions between a user and applications are described. Although embodiments have been described with reference to specific exemplary embodiments, it will be evident that various modifications and changes can be made to these exemplary embodiments without departing from the broader spirit and scope of the present application. Accordingly, the specification and drawings are to be regarded in an illustrative rather than a restrictive sense.

What is claimed is:

1. A system for managing interactions between a user and applications, the system comprising:
a processor operable to:
receive a command from a user, the command including a voice command;
derive one or more key words from the voice command, the one or more key words being associated with one or more executing devices, wherein the one or more executing devices are associated with one or more applications;
select, based on the one or more key words, an executing device for executing the voice command; and
direct the voice command to the executing device to execute the voice command; and
a parser in communication with the processor and operable to:
parse the voice command, the parsing including processing a natural language associated with the voice command.

2. The system of claim 1, wherein the one or more executing devices are associated with performing one or more of the following: a text message communication, an email communication, a navigation control, an automobile control, and a travel booking.

3. The system of claim 1, wherein the command includes one or more of the following: reading an email, converting the email from text-to-speech, responding to the email, receiving a message, responding to multiple messages, taking a call, making a call, cancelling a call, adding one or more interlocutors to a call, recording a call, navigation searching, voice direction responding, finding one or more places of interest, providing car status, and adjusting car settings.

4. The system of claim 1, wherein the processor is further operable to:
receive, from the executing device, a notification associated with one or more events;
convert the notification into a speech; and
provide the notification to the user by reproducing the speech.

5. The system of claim 4, wherein the one or more events include one or more of the following: receiving an email, receiving a text message, and receiving a call.

6. The system of claim 1, wherein the processor is further operable to:
receive, from a first executing device of the one or more executing devices, a first notification associated with a first event;
receive, from a second executing device of the one or more executing devices, a second notification associated with a second event;
based on the first notification and the second notification, generate a third notification, the third notification including data associated with the first event and the second event;
convert the third notification into a speech; and
provide the third notification to the user by reproducing the speech.

7. The system of claim 1, wherein the processor is further operable to:
receive, from the executing device, a command execution confirmation; and
provide the command execution confirmation to the user by reproducing the command execution confirmation by a speech.

8. The system of claim 1, wherein directing the voice command to the executing device includes directing the voice command to a further processor, the further processor being associated with the executing device.

9. The system of claim 1, wherein the command is provided by the user using a user device.

10. The system of claim 9, wherein the executing device includes one the following: a remote digital device, a virtual machine, and the user device.

11. A method for managing interactions between a user and applications, the method comprising:
receiving, by a processor, a command from a user, the command including a voice command;
parsing, by a parser, the voice command, the parsing including processing a natural language associated with the voice command;
based on the parsing, deriving, by the processor, one or more key words from the voice command, the one or more key words being associated with one or more executing devices, wherein the one or more executing devices are associated with one or more applications;
based on the key words, selecting, by the processor, an executing device for executing the voice command; and
directing, by the processor, the voice command to the executing device to execute the voice command.

12. The method of claim 11, wherein the one or more executing devices are associated with performing one or more of the following: a text message communication, an email communication, a navigation control, an automobile control, and a travel booking.

13. The method of claim 11, wherein the command includes one or more of the following: reading an email, converting the email from text-to-speech, responding to the email, receiving a message, responding to multiple messages, taking a call, making a call, cancelling a call, adding one or more interlocutors to a call, recording a call, navigation searching, voice direction responding, finding one or more places of interest, providing car status, and adjusting car settings.

14. The method of claim 11, further comprising:
receiving, by the processor, from the executing device, a notification associated with one or more events;
converting, by the processor, the notification into a speech; and
providing, by the processor, the notification to the user by reproducing the speech.

15. The method of claim 14, wherein the one or more events include one or more of the following: receiving an email, receiving a text message, and receiving a call.

16. The method of claim 11, further comprising:
receiving, by the processor, from a first executing device of the one or more executing devices, a first notification associated with a first event;
receiving, by the processor, from a second executing device of the one or more executing devices, a second notification associated with a second event;
generating, by the processor, based on the first notification and the second notification, a third notification, the third notification including data associated with the first event and the second event;
converting, by the processor, the third notification into a speech; and
providing, by the processor, the third notification to the user by reproducing the speech.

17. The method of claim 11, further comprising:
receiving, by the processor, from the executing device, a command execution confirmation; and
providing, by the processor, the command execution confirmation to the user by reproducing the command execution confirmation by a speech.

18. The method of claim 11, wherein directing the voice command to the executing device includes directing the voice command to a further processor, the further processor being associated with the executing device.

19. The method of claim 11, wherein the executing device includes one the following: a remote digital device, a virtual machine, and a user device.

20. A system for managing interactions between a user and applications, the system comprising:
a processor operable to:
receive a command from a user, the command including a voice command;
derive one or more key words from the voice command, the one or more key words being associated with one or more executing devices, wherein the one or more executing devices are associated with one or more applications;
select, based on the one or more key words, an executing device for executing the voice command;
direct the voice command to the executing device to execute the voice command;
receive, from a first executing device of the one or more executing devices, a first notification associated with a first event;
receive, from a second executing device of the one or more executing devices, a second notification associated with a second event;
based on the first notification and the second notification, generate, a third notification, the third notification including data associated with the first event and the second event;
convert the third notification into a speech;
provide the third notification to the user by reproducing the speech;
receive, from the executing device, a command execution confirmation; and
provide the command execution confirmation to the user by reproducing the command execution confirmation by a speech; and
a parser in communication with the processor and operable to:
parse the voice command, the parsing including processing a natural language associated with the voice command.
